(19) United States
(12) Patent Application Publication
(10) Pub. No.: US 2017/0020287 A1
(43) Pub. Date: Jan. 26, 2017

(54) SUPPORT BRACKET SYSTEM

(71) Applicant: QTran, Inc., Milford, CT (US)

(72) Inventors: John M. Tremaine, New Canaan, CT (US); Adrian R. Teschemaker, West Haven, CT (US)

(21) Appl. No.: 15/137,915

(22) Filed: Apr. 25, 2016

Related U.S. Application Data
(60) Provisional application No. 62/152,643, filed on Apr. 24, 2015.

(51) Int. Cl. A47B 96/06; F16B 1/00

(52) U.S. Cl. CPC A47B 96/068; F16B 1/00; F16B 2001/0035

(57) ABSTRACT

The present invention is directed to a support bracket system configured to support and/or hold one or more panels so that a panel array may be provided by the support bracket system. The support bracket system may include a vertical end support on each vertical end of the support bracket system. The support bracket system may also include at least one top horizontal support, and at least one bottom horizontal support. The support bracket system may also include at least one vertical middle support and at least one horizontal middle support that are attached together in order to form an internal support structure of the support bracket system. The support bracket system provides a mechanism by which the one or more panels may be affixed to a surface without showing any visible means of support.

### CROSS-REFERENCE TO RELATED APPLICATIONS

This application claims priority to U.S. Provisional Appl. No. 62/152,643 filed Apr. 24, 2015, which is hereby incorporated by reference in its entirety.

### BACKGROUND OF THE INVENTION

1. Field of the Invention

The present invention generally relates to a support bracket system, and more particularly relates to a support bracket system that may be configured to hold panels and/or shelving units without showing any visual means of attachment to a base for the support bracket system.

2. Description of Related Art

Conventional wall coverings typically require some type of fastener or adhesive to adhere the covering to the wall. Fasteners can be unsightly on the wall covering and adhesives can be difficult to apply and may lose their adhesion over time. Furthermore, conventional shelving and cabinet systems typically require fastening to a structural member that may already be covered by a wall covering, resulting in the dual disadvantage of the structural member being difficult to locate and the wall covering will be damaged as a result of the installation of the shelving and/or cabinets. Furthermore, once installed shelving and/or cabinets are not adjustable, and any adjustments made will result in further damage to the wall coverings. Therefore, what is needed is a visually pleasing wall covering that is also capable of receiving items, such as shelves and cabinets, without the disadvantages of conventional wall coverings.

### SUMMARY OF THE INVENTION

The present invention is designed to overcome the above noted limitations that are attendant upon the use of conventional support and/or shelving systems and, toward this end, it contemplates the provision of a novel support bracket system.

It is an object of the present invention to provide a support bracket system that is configured to retain wall panels thereon with equal reveal for all sides of each panel, or optionally allow the wall panels to be flushed tight with the supports of the support bracket system.

It is another object of the present invention to provide a support bracket system that shows no visible means of support.

It is yet another object of the present invention to provide a support bracket system that allows wall panels to be held thereon without the use of visible fasteners.

It is still another object of the present invention to provide a support bracket system that can be used to provide connecting points for the installation of shelving or cabinets and the like.

According to an exemplary embodiment of the present invention, a support bracket system is provided that may include at least one vertical support having a longitudinal body and at least one channel formed in the longitudinal body and extending along at least a portion of the longitudinal body, and at least one horizontal support having a body portion and at least one central track formed in the body portion and extending along at least a portion of the body portion. The at least one horizontal support may be configured for attachment to at least one of the at least one vertical supports, and when the at least one horizontal support is attached to the at least one vertical support one channel of the at least one channel of the vertical support is integral with one central track of the at least one track of the horizontal support.

According to the exemplary embodiment of the present invention, the support bracket system may also include at least one support pin configured to connect the at least one vertical support with the at least one horizontal support, and the support pin may include a head portion and a tapered body portion.

According to the exemplary embodiment of the present invention, the at least one vertical support may include at least one pin hole configured to receive the head portion of the support pin, and the at least one horizontal support may include a longitudinal bore configured to receive the tapered body portion of the support pin.

According to the exemplary embodiment of the present invention, the at least one channel of the vertical support may include a first channel formed in a first side of the longitudinal body, and a second channel formed in a second side of the longitudinal body.

According to the exemplary embodiment of the present invention, the first channel may include an overhanging rib positioned on opposing sides of an opening to the first channel, and each of the overhanging ribs comprises one or more teeth.

According to the exemplary embodiment of the present invention, the horizontal support may include at least one mounting track extending from the body portion and positioned substantially parallel with the central track.

According to the exemplary embodiment of the present invention, the at least one mounting track is configured to slidenly receive one or more magnets.

According to the exemplary embodiment of the present invention, the at least one mounting track comprises a groove configured to receive one or more fasteners.

According to the exemplary embodiment of the present invention, the horizontal support may include a ledge positioned on the body portion adjacent to one of the at least one mounting tracks.

According to the exemplary embodiment of the present invention, the support bracket system is configured to support and retain at least one panel of a panel array.

According to the exemplary embodiment of the present invention, the support bracket system may also include a shelf support received within the channel of the vertical support, and including a substantially rectangular support structure having at least one rounded corner, and a knurled rod configured for positioning within the channel of the vertical support.

According to the exemplary embodiment of the present invention, the shelf support may also include a hollow support having the at least one rounded corner, and a support beam configured for receipt within the hollow support.

According to the exemplary embodiment of the present invention, the shelf support may also include one or more posts extending from the rectangular support structure.

According to the exemplary embodiment of the present invention, the at least one vertical support includes a first vertical support and a second vertical support positioned substantially parallel to the first vertical support, and the at least one horizontal support includes a first horizontal support and a second horizontal support positioned substantially parallel to the first horizontal support, and the first vertical support is connected to the second vertical support by the first horizontal support and the second horizontal support.

According to the exemplary embodiment of the present invention, at least one of the first horizontal support or the second horizontal support is attached to a surface by at least one fastener.

According to the exemplary embodiment of the present invention, at least one panel is attached to the support bracket system and positioned so as to be bounded by the first vertical support, the second vertical support, the first horizontal support and the second horizontal support.

According to the exemplary embodiment of the present invention, the central track of the at least one horizontal support may include an opening and a substantially trapezoidal passage connected to the opening, and the cross-sectional size of the opening is less than the cross-sectional size of the passage.

According to another exemplary embodiment of the present invention, a vertical support is provided that may include a longitudinal body and at least one channel formed in the longitudinal body and extending along at least a portion of the longitudinal body.

According to this or other exemplary embodiments of the present invention, the at least one channel of the vertical support may include a first channel formed in a first side of the longitudinal body, and a second channel formed in a second side of the longitudinal body.

According to this or other exemplary embodiments of the present invention, the first channel may include an overhanging rib positioned on opposing sides of an opening to the first channel, and each of the overhanging ribs comprises one or more teeth.

According to another exemplary embodiment of the present invention a horizontal support is provide that may include a body portion and at least one central track formed in the body portion and extending along at least a portion of the body portion.

According to this or other exemplary embodiments of the present invention, the horizontal support may include at least one mounting track extending from the body portion and positioned substantially parallel with the central track.

According to this or other exemplary embodiments of the present invention, the at least one mounting track is configured to slidenly receive one or more magnets.

According to this or other exemplary embodiments of the present invention, the at least one mounting track comprises a groove configured to receive one or more fasteners.

According to this or other exemplary embodiments of the present invention, the horizontal support may include a ledge positioned on the body portion adjacent to one of the at least one mounting tracks.

### BRIEF DESCRIPTION OF THE SEVERAL VIEWS OF THE DRAWINGS

For a fuller understanding of the nature and object of the present invention, reference should be had to the following detailed description taken in connection with the accompanying drawings, in which:

FIG. 1 is a front view of an exemplary embodiment of a support bracket system according to the present invention with exemplary panels installed thereon;

FIG. 2 is a side view of the exemplary support bracket system according to the present invention;

FIG. 2A is an expanded view of Section A from FIG. 2;

FIG. 3 is an isometric view of the exemplary support bracket system according to the present invention;

FIG. 3A is an expanded view of Section A from FIG. 3;

FIG. 4 is an exploded isometric view of an exemplary horizontal supports and an exemplary vertical support of the support bracket system according to the present invention;

FIG. 5 is an exploded top plan view of the exemplary horizontal supports and the exemplary vertical support of the support bracket system according to the present invention;

FIG. 5B is a cross-sectional view taken along line 5B-5B from FIG. 5;

FIG. 6 is a top plan view of the exemplary horizontal supports and the exemplary vertical support of the support bracket system according to the present invention;

FIG. 7 is a top plan view of an exemplary pin that may be used with the support bracket system according to the present invention;

FIG. 7A is a cross-sectional view taken along line 7A-7A from FIG. 7;

FIG. 8 is an isometric view of the exemplary pin;

FIG. 9 is a front view of the exemplary pin;

FIG. 10 is a side view of the exemplary pin;

FIG. 11 is an exploded isometric view of the exemplary horizontal supports and the exemplary vertical support of the support bracket system according to the present invention along with various fasteners that may be used with the support bracket system;

FIG. 12 is a bottom plan view of an exemplary bottom horizontal support of the support bracket system according to the present invention;

FIG. 13 is an isometric view of the exemplary bottom horizontal support of the support bracket system according to the present invention;

FIG. 14 is a side view of the exemplary bottom horizontal support of the support bracket system according to the present invention;

FIG. 15 is a front view of the exemplary bottom horizontal support of the support bracket system according to the present invention;

FIG. 16 is a bottom plan view of an exemplary top horizontal support of the support bracket system according to the present invention;

FIG. 17 is an isometric view of the exemplary top horizontal support of the support bracket system according to the present invention;

FIG. 18 is a side view of the exemplary top horizontal support of the support bracket system according to the present invention;

FIG. 19 is a front view of the exemplary top horizontal support of the support bracket system according to the present invention;

FIG. 20 is an isometric view of an exemplary vertical support of the support bracket system according to the present invention;

FIG. 21 is a front view of the exemplary vertical support of the support bracket system according to the present invention;

FIG. 21A is a cross-sectional view taken along line 21A-21A in FIG. 21;

FIG. 22 is a side view of the exemplary vertical support of the support bracket system according to the present invention;

FIG. 22A is an expanded view of Section A from FIG. 22;

FIG. 23 is a front view of an exemplary end vertical support of the support bracket system according to the present invention;

FIG. 23A is a cross-sectional view taken along line 23A-23A in FIG. 23;

FIG. 24 is an isometric view of the exemplary vertical support of the support bracket system according to the present invention;

FIG. 25 is a front view of the exemplary vertical support of the support bracket system according to the present invention;

FIG. 25A is an expanded view of Section A from FIG. 25;

FIG. 25B is an expanded view of Section B from FIG. 25;

FIG. 26 is a side view of an exemplary adjustable support unit being installed on an exemplary vertical support of the support bracket system according to the present invention;

FIG. 27 is a side view of the exemplary adjustable support unit installed on an exemplary vertical support of the support bracket system according to the present invention;

FIG. 28 is a side view of the exemplary adjustable support unit with a shelf installed on an exemplary vertical support of the support bracket system according to the present invention;

FIG. 29 is a side view of an exemplary adjustable support unit with a shelf installed on an exemplary vertical support of the support bracket system according to the present invention;

FIG. 30 is an exploded view of the exemplary adjustable support unit;

FIG. 31 is an isometric view of an exemplary adjustable support unit;

FIG. 32 is an isometric view of an exemplary adjustable support unit;

FIG. 33 is an exploded view of an exemplary adjustable support unit;

FIG. 34 is an isometric view of the assembled exemplary adjustable support unit from FIG. 33;

FIG. 35 is a top plan view of a spacer that may be used with the support bracket system according to the present invention;

FIG. 36 is a rotated top plan view of the spacer from FIG. 35;

FIG. 37 is an isometric view of the spacer that may be used with the support bracket system according to the present invention;

FIG. 38 is a side view of the spacer used with the top horizontal support of the support bracket system according to the present invention;

FIG. 39 is a side view of the spacer used with the middle horizontal support of the support bracket system according to the present invention; and

FIG. 40 is a side view of the spacer used with the bottom horizontal support of the support bracket system according to the present invention.

### DETAILED DESCRIPTION OF THE INVENTION

The present invention now will be described more fully hereinafter with reference to the accompanying figures, in which exemplary embodiments of the invention are shown. The invention may, however, be embodied in many different forms and should not be construed as limited to the embodiments set forth herein. Like reference numerals refer to like elements throughout.

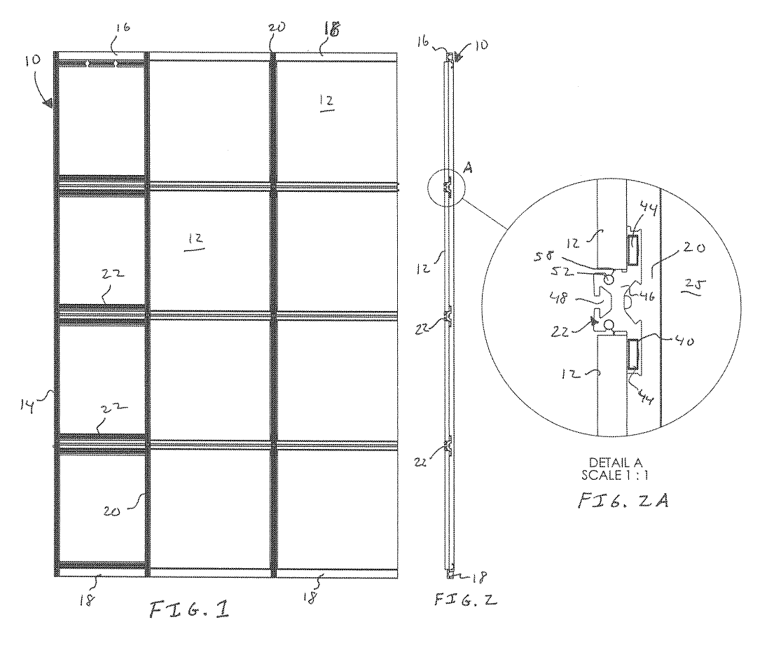

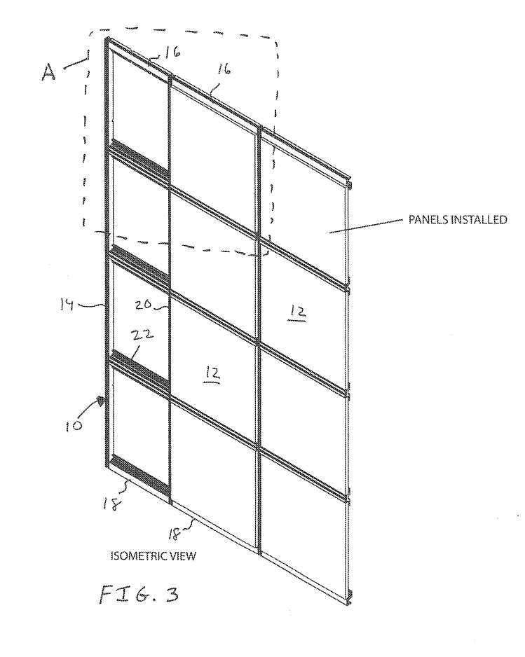

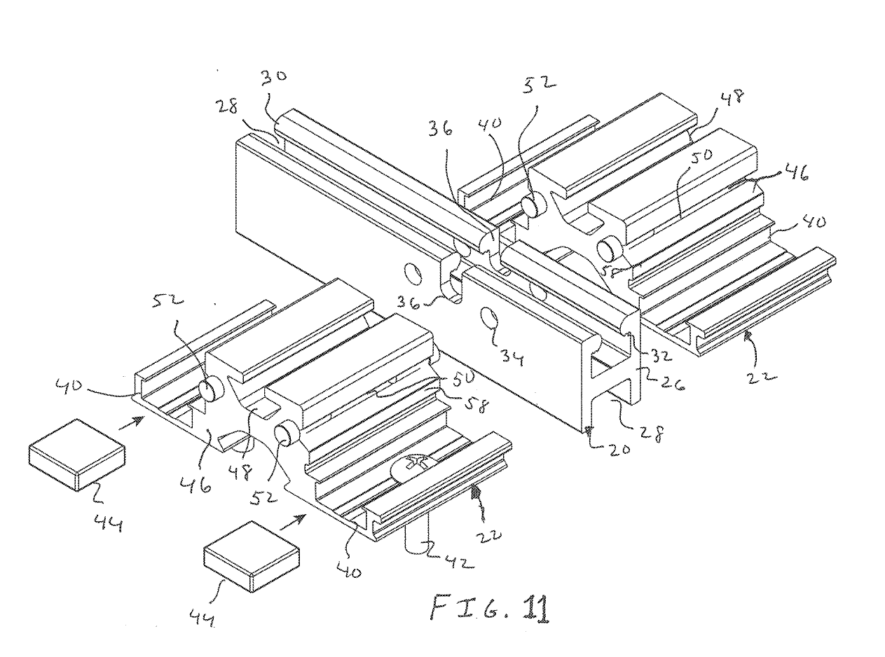

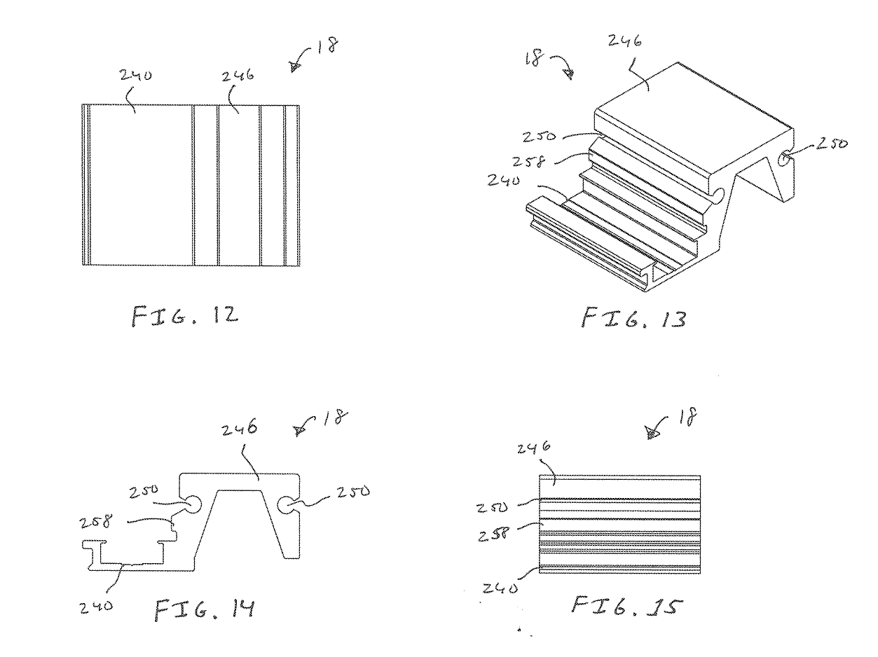

Referring now to FIGS. 1-2, 2A, 3 and 3A, therein illustrated is an exemplary embodiment of a support bracket system, generally indicated by reference numeral 10, according to the present invention. The support bracket system 10 is configured to support and/or hold one or more panels 12 so that a panel array may be provided by the support bracket system 10. The panel array made of the one or more panels 12 may for example be a plurality of wall panels within a residential, commercial and/or industrial unit. The residential unit may for example, be an apartment and/or condo unit. The support bracket system 10 may include a vertical end support 14 on each vertical end of the support bracket system 10, for clarity it is understood that the right side vertical end support is not shown in FIGS. 1-3. The support bracket system 10 may also include at least one top horizontal support 16, shown in greater detail in FIGS. 16-19, and at least one bottom horizontal support 18, which is shown in greater detail in FIGS. 12-15. The support bracket system 10 may also include at least one vertical middle support 20 and at least one horizontal middle support 22 that are attached together as discussed further below in order to form the internal support structure of the support bracket system 10.

Still referring to FIGS. 1-2, 2A, 3 and 3A, the support bracket system 10 provides a mechanism by which the one or more panels 12 may be affixed to a wall 25 or other surface without showing any visible means of support. As discussed further below, the top horizontal support 16, bottom horizontal support 18, vertical middle support 20 and horizontal middle support 22 may all be attached to the wall 25 without any visible means of support and/or attachment being visible when the panels 12 are installed on the support bracket system 10. Furthermore, the supports 14, 16, 18, 20, 22 of the support bracket system 10 engage with each other in order to provide for a self-supporting structure that can be installed in an efficient manner without the need for fastener connections between many of the supports 14, 16, 18, 20, 22. It is also understood that while the support bracket system 10 is shown, and may be discussed, with respect to covering an entire wall 25 or surface, the support bracket system 10 may be configured to only cover a particular portion of the wall 25 or other surface and may have any dimension or size depending upon the required application of the support bracket system.

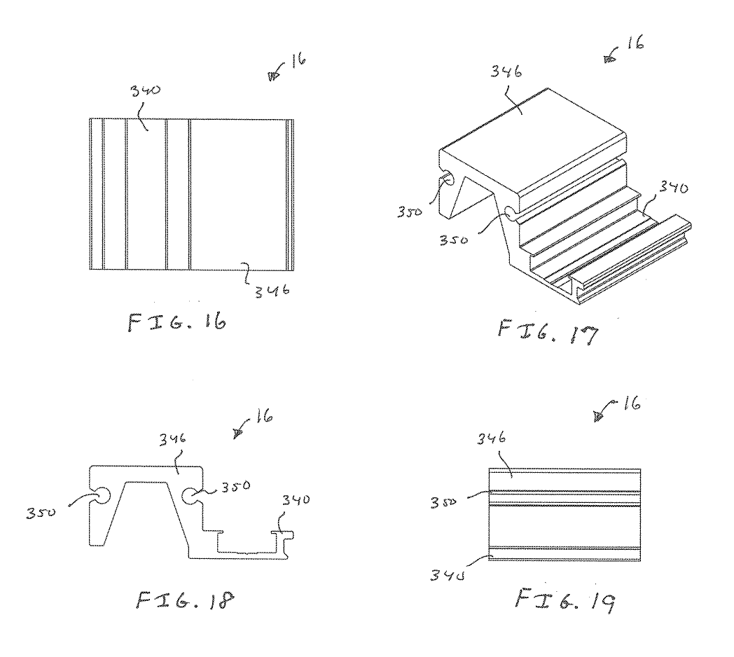

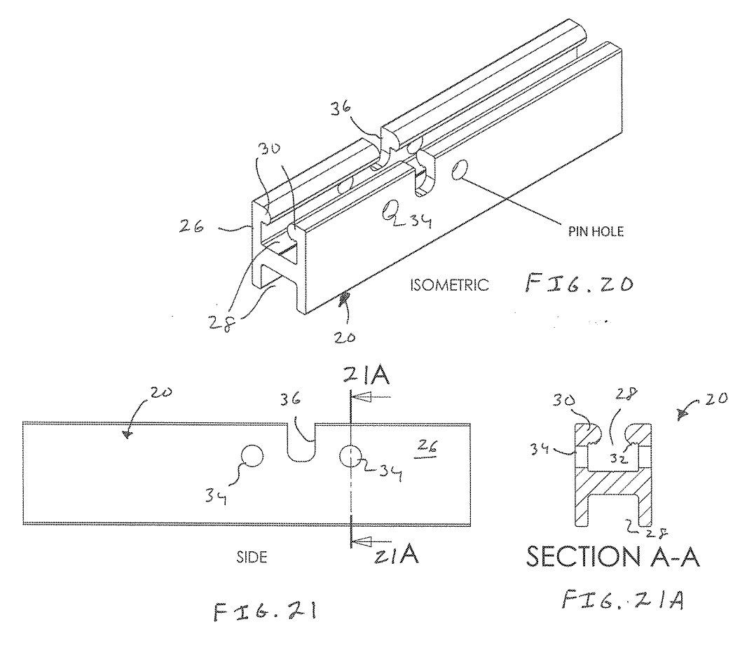

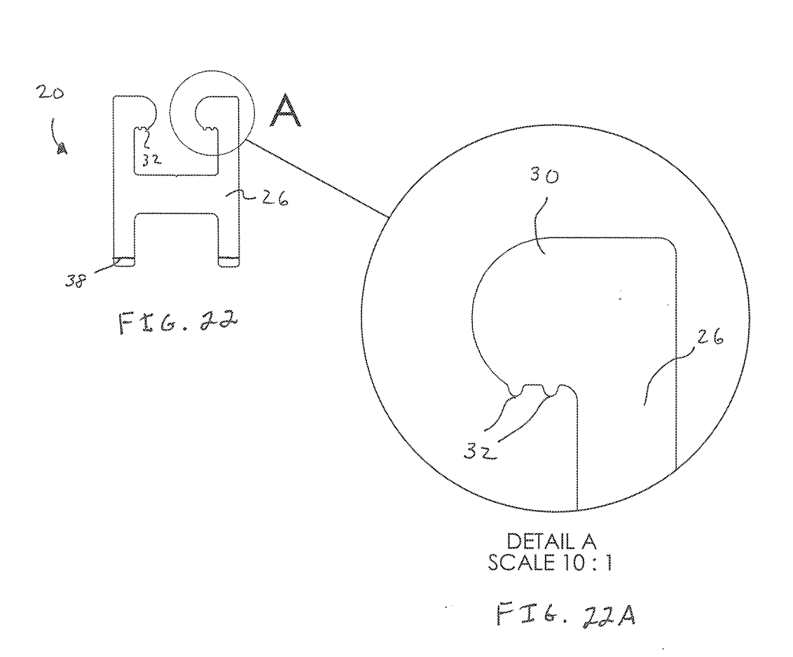

Referring now to FIGS. 20-21, 21A, 22, 22A, 24-25, 25A and 25B, each vertical middle support 20 may include a longitudinal body 26 having substantially a cross-sectional configuration of an H or I, depending upon the orientation of the longitudinal body 26, and forming a pair of opposing channels 28 running along the length of the longitudinal body 26 of the vertical middle support 20. One of the channels 28 may include overhanging ribs 30 extending from the longitudinal body 26 towards a centerline of the channel 28, and may be configured to accept a metal bar or a screw bar for the mounting of one or more objects in any location of the support bracket system 10 that has an exposed channel 28 of the vertical middle supports 20. Each of the overhanging ribs 30 may optionally include one or more teeth 32 that extend from the overhanging rib 30 in a direction towards the base of the channel 28, and the one or more teeth 32 may optionally extend the entire length of each overhanging rib 30. The vertical middle support 20 may also include one or more pin holes 34 formed through the longitudinal body 26 and extending into one of the channels 28. The pin holes 34 may be grouped in sets of two, but it is understood that the present invention is not limited to any numbering, grouping and/or configuration of pin holes 34 in the vertical middle support 20. The vertical middle support 20 may also include cross-notches 36 formed therein, in which a portion of the longitudinal body 26 is cutout to form an opening that extends through both sides of the vertical middle support 20. These cross-notches 36 may be positioned between a pair of pin holes 34, and operate in conjunction with the horizontal middle supports 22, as discussed further below. The vertical middle support 20 may also include cutouts 38 at each end thereof.

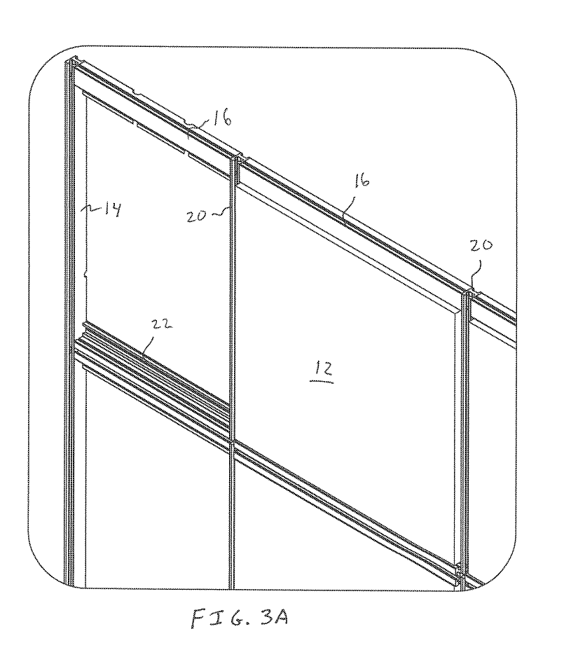

Referring now to FIGS. 2A, 4-5, 5B, 6 and 11, the horizontal middle supports 22 are shown. The horizontal middle supports 22 may include a pair of mounting tracks 40 that are configured to receive fasteners 42, such as screws, bolts and/or nails, in order to affix the horizontal middle supports 22, and the support bracket system 10 as a whole, to a wall or surface. The pair of mounting tracks 40 are may also be configured to receive one or more magnets 44 that allow the panels 12 to be installed on the support bracket system 10. The panels 12 may themselves be made of a ferrous metal or have ferrous metal inserts (not shown) positioned in the panels 12 in order to allow the magnets 44 to secure the panels 12 to the horizontal middle support 22. The horizontal middle support 22 may also include a body portion 46 positioned between the pair of mounting tracks 40. The body portion 46 may include a central track 48 that extends along the length of the body portion 46, and has a cavity that has at least one dimension that is greater in size than the opening to the central track 48. The central track 48 may preferably have a trapezoidal or trapezoidal like cross-section, but it is understood that the present invention is not limited to any particular cross-sectional shape of the central track 48. The central track 48 may be configured to accept a metal bar or a screw bar to mount objects in any location on the support bracket system 10 in which the central track 48 of any horizontal middle support 22 may be located. The body portion 46 of the horizontal middle support 22 may also include at least one longitudinal through bore 50 that may extend at least partially the length of the body portion 46. Each of the one or more longitudinal through bores 50 may have an opening over at least a portion of the degrees of its circumference, and the opening may extend into a wider arc area. The longitudinal through bore 50 may be configured to receive a support pin 52 in each end of the longitudinal through bore 50.

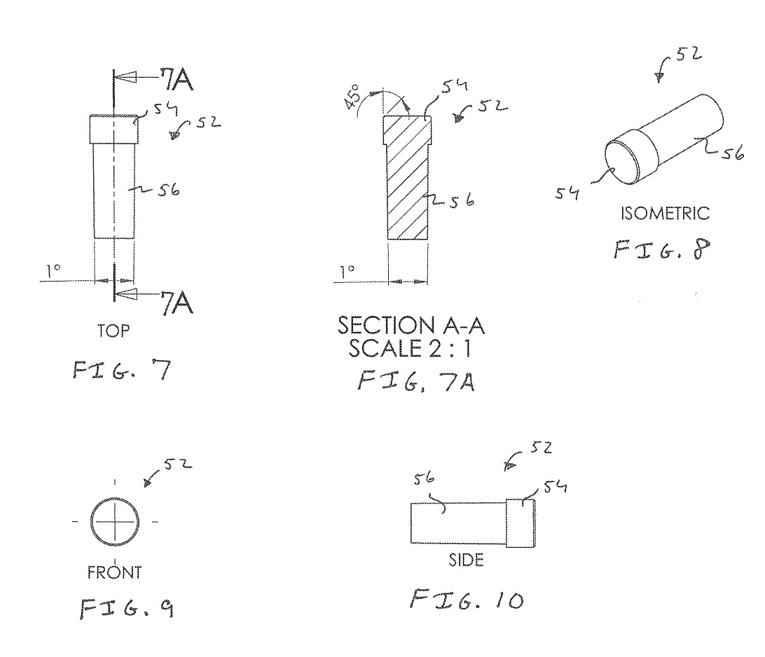

As shown in greater detail in FIGS. 7, 7A and 8-10, the support pin 52 may include a head portion 54 and a tapered body portion 56 that has a taper, for example of 1°, from the head portion 54 to the opposite end of the support pin 52. The support pin 52 is preferably tapered in order to allow insertion of the support pin 52 into the longitudinal through bore 50 of the horizontal middle support 22 up to the head portion 54, so that the head portion 54 extends from the body portion 46 of the horizontal middle support 22. The taper of the support pin 52 facilitates a snug fit of the support pin 52 in the body portion 46 so that the support pin 52 is prevented from falling out of the horizontal middle support 22 under normal conditions.

Referring again to FIGS. 2A, 4-5, 5B, 6 and 11, the horizontal middle support 22 may also include a ledge 58 formed on one side of the body portion 46 and extending towards the mounting track 40 positioned on the side of the body portion 46. The ledge 58 is configured to act as a spacing mechanism for the panels 12 so that the panels 12 preferably can have equal spacing and/or reveal around all perimeter sides of the panel 12 in order to provide a uniform appearance when the panels 12 are installed on the support bracket system 10.

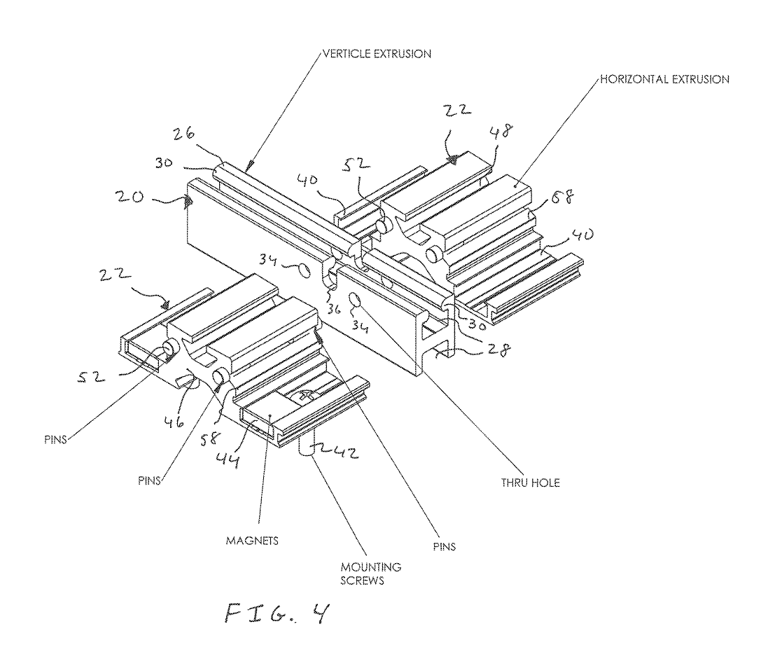

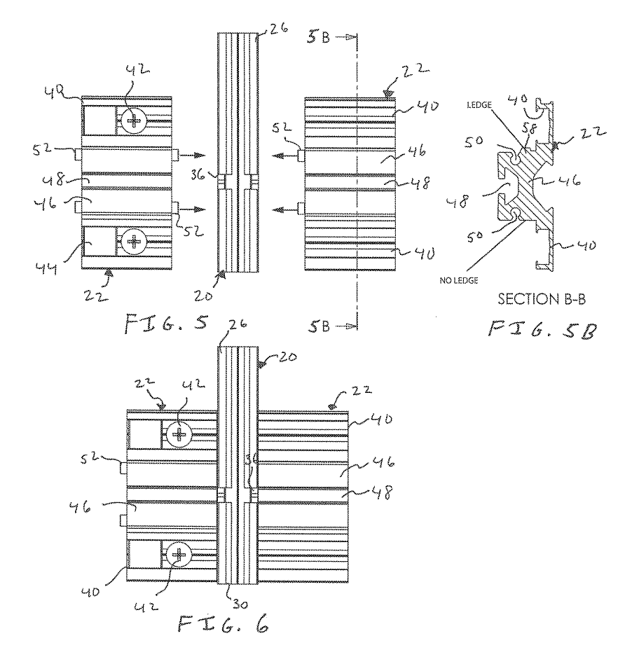

Referring now to FIGS. 4-5 and 11, the mechanical interaction of the exemplary vertical middle support 20 and a pair of the exemplary horizontal middle supports 22 of the support bracket system 10 will be discussed. It is understood that the sizes and/or length s of these supports shown in these drawings is merely for illustrative purposes in order to facilitate understanding of the exemplary embodiments of the present invention. Once the appropriate number of support pins 52 have been securely installed in the longitudinal through bores 50 of the horizontal middle supports 22, the horizontal middle supports 22 may be affixed to the vertical middle support 20 by inserting the head portions 54 of the support pins 52 into the appropriately corresponding pin holes 34 formed in the longitudinal body 26 of the vertical middle support 20. This configuration and interaction provides for rapid and efficient assembly of the support bracket system 10, because no mechanical fasteners, such as screws, bolts or the like, are required to connect the horizontal middle supports 22 to the vertical middle support 20. Furthermore, as shown for example by FIG. 6, and apparent from FIGS. 4-5 and 11, once the horizontal middle supports 22 are installed on the vertical middle support 20, the central tracks 48 of the horizontal middle supports 22 line up with the corresponding cross-notches 36 of the vertical middle support 20 in order to provide a continuous track that may be used for connecting points for the installation of shelving or cabinets and the like. As mentioned above, the central tracks 48 may be configured to accept a metal bar or a screw bar to either directly mount the shelving, cabinets or other storage devices to the support bracket system 10 or to retain a mounting device (not shown) that may then be used to secure the shelving, cabinets or other storage devices.

Referring now to FIGS. 23 and 23A, the support bracket system 10 according to the present invention may also include the vertical end support 14 positioned on each vertical end of the support bracket system 10. The vertical end support is 14 may be substantially the same as the vertical middle support 20, and may include a longitudinal body 126, a pair of channels 128, a pair of overhanging ribs 130, each optionally having at least one tooth 132. The channel 128 of the pair of channels 128 that includes the overhanging rib 130 may be configured to accept a metal bar or screw bar to mount objects in any location where the channel 128 is available. The vertical end support 14 may also include one or more fastener channels 135 formed through the longitudinal body 126 in order to allow a fastener, such as a screw, bolt or the like, to be inserted through the longitudinal body 126 in order to affix the vertical end support 14 to one or more horizontal middle supports 22. The fastener (not shown) used to secure the vertical end support 14 to the horizontal middle supports 22 may be received and retained in the corresponding longitudinal through bore 50 of the horizontal middle support 22. The vertical end support 14 may also include one or more notches 137 to allow passage of electrical wiring, plumbing or the like to be passed between the support bracket system 10 and the wall or surface on which it may be affixed.

The support bracket system 10 may also include at least one top horizontal support 16 and at least one bottom horizontal support 18. The bottom horizontal support 18 is shown in FIGS. 12-15, and is constructed substantially the same as the middle horizontal support 22, and may include a mounting track 240, a body portion 246 with at least one longitudinal through bore 250 and a ledge 285. It is understood that the bottom horizontal support 18 finishes the bottom portion of the support bracket system 10. The top horizontal support 16 is shown in FIGS. 16-19, and is constructed substantially the same as the middle horizontal support 22, and may include a mounting track 340 and a body portion 346 with at least one longitudinal through bore 350. It is understood that the top horizontal support 16 finishes the top portion of the support bracket system 10, but it is further understood that it would also be possible to use a middle horizontal support 22 on the top portion of the support bracket system 10 as well, it would just be that the appearance may not be as complete. The prevent invention is not limited to any particular location within the support bracket system 10 of the top horizontal support 16, bottom horizontal support 18 or the middle horizontal support 22, and that the names are merely for purposes of identification and are not limiting.

The construction, operation and potential use of the support bracket system 10 will now be discussed with reference to FIGS. 1, 2A, 3 and 3A. Exemplary embodiments of the support bracket system 10 may be installed on the wall 25 or similar surface, and construction of the support bracket 10 may start with one vertical end support 14 and an appropriate number of horizontal middle supports 22 being installed on the vertical end support 14 through the use of appropriate fastener mechanisms, such as screws and/or bolts or the like. Additionally, a top horizontal support 16 and bottom horizontal support 18 may be installed at appropriate locations on the vertical end support 14. Once the desired number of supports 16, 18, 22 have been installed, pins 52 may be inserted into the longitudinal through bores 50, 250, 350 of the supports 16, 18, 22, and then the vertical middle support 20 may be installed on the supports 16, 18, 22. This process is repeated until the support bracket system 10 has been installed over the desired area, and then another vertical end support 14 is installed in order to complete the support bracket system 10 and maintain the support bracket system in place. It is understood that each of the supports 16, 18, 22 may be affixed to the wall 25 or surface through appropriate fasteners 42. Furthermore, it is also understood that the supports 16, 18, 22 of the support bracket system 10 are supported by the vertical middle supports 20 and the vertical end supports 14, such that it may not be necessary to use fasteners 42 on all of the supports 16, 18, 22 in the support bracket system 10. Once the support bracket system 10 has been installed, the wall panels 25 may be affixed to the magnets 44 of the support bracket system 10 in order to hide any undesired visual appearances. Furthermore, shelving and/or cabinet systems, as well as any other types of storage systems, may be installed on the support bracket system 10 through use of the mounting tracks 48, 248, 348 and channels 28, 128, as discussed more fully above.

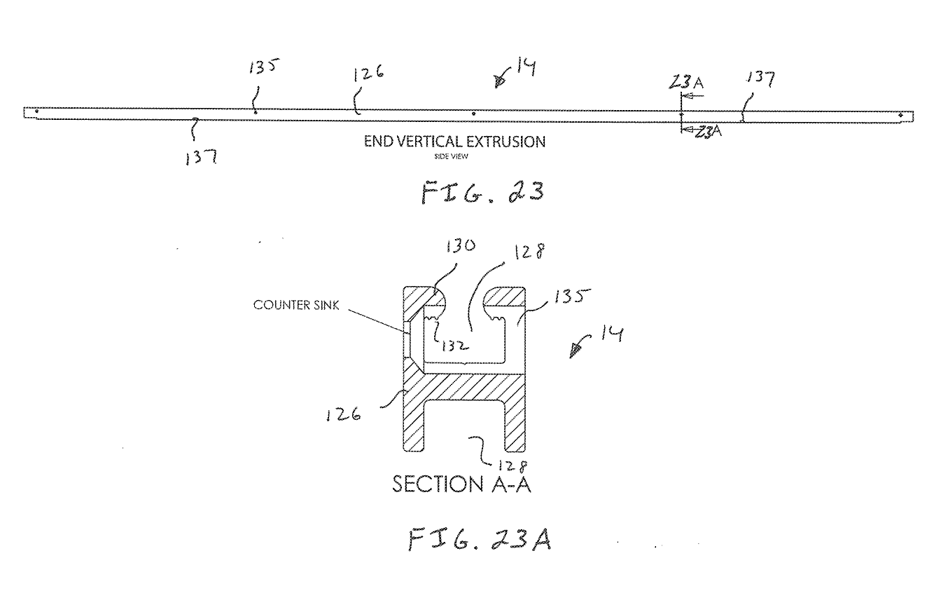

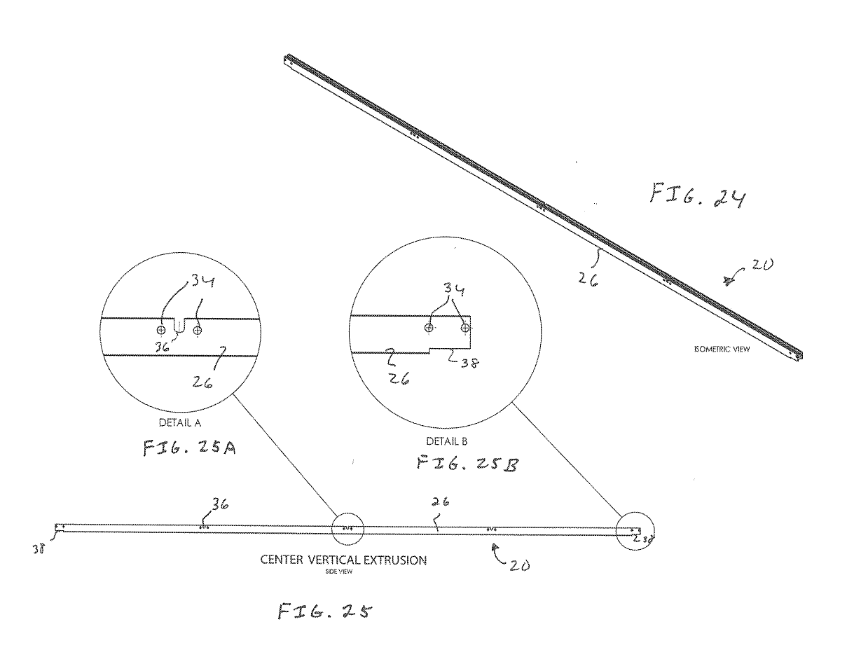

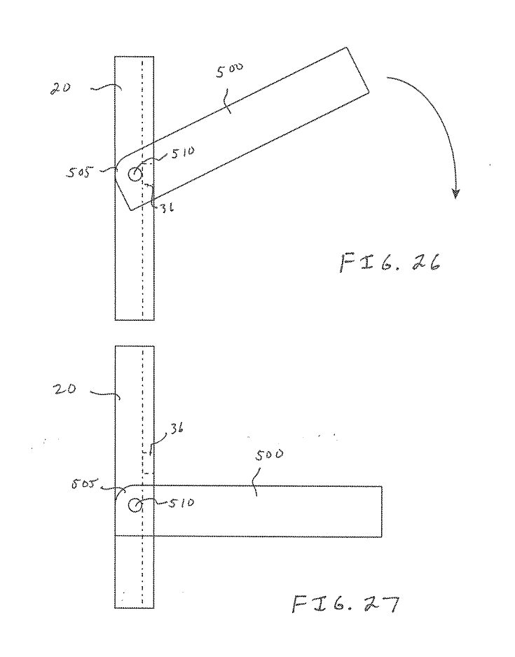

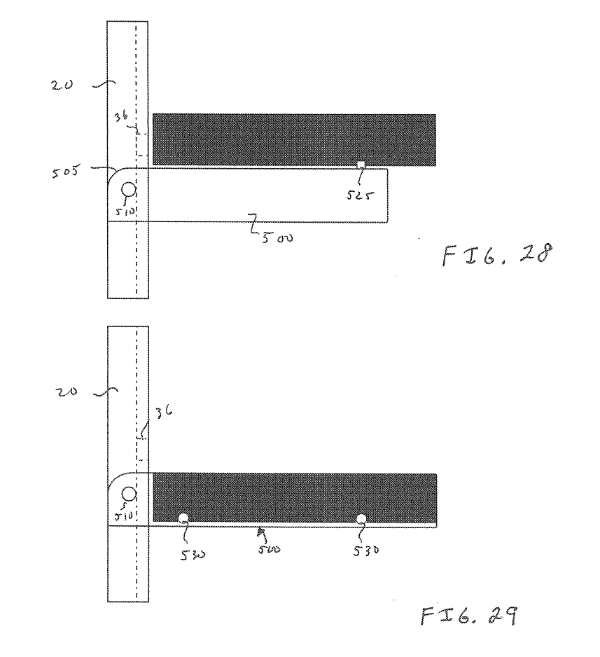

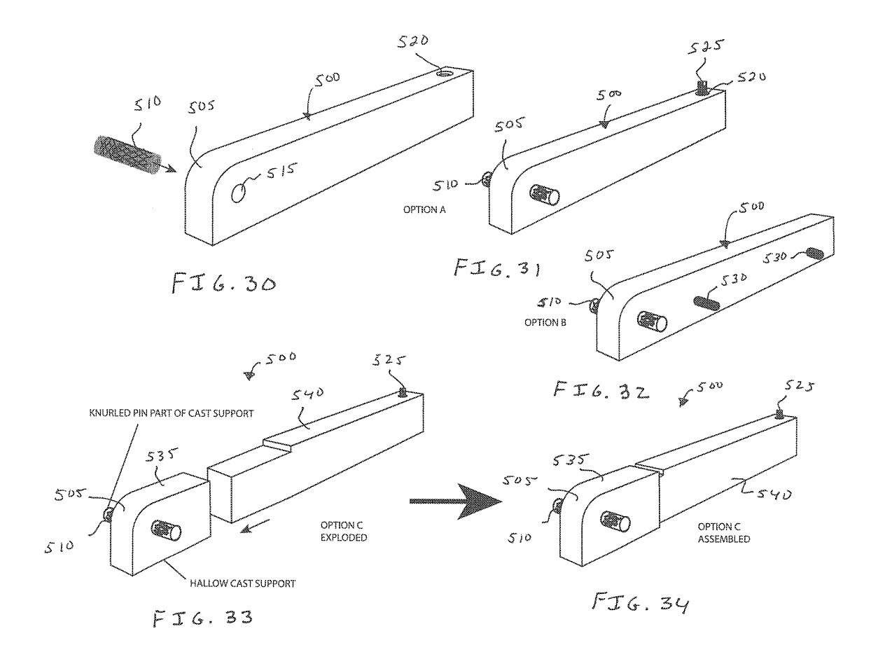

For example, the shelving support system shown in FIGS. 26-34 may be used with the bracket support system 10 of the present invention as follows. An exemplary shelf support 500 may have a substantially rectangular configuration with one substantially rounded corner 505. A knurled rod 510 may be inserted into the body of the shelf support 500 though a bore hole 515 in the shelf support 500. The knurled rod 510 may preferably be press fit into the shelf support 500 so that it is securely retained in the shelf support 500. The shelf support 500 may also include one or more holes 520 for receiving one or more posts 525, 530 at various locations depending upon the desired configuration of the shelves that are to be constructed from the shelf support 500. The shelf support 500 may be installed on the bracket support system 10 by inserting the knurled rod 510 though one of the cross-notches 36 in one of the vertical middle supports 20. The shelf support 500 is then raised or lowered along the vertical middle support 20 relative to the cross-notch 36, and then rotated downwardly, as shown for example in FIG. 26, so that the knurled rod 510 engages with the teeth 32 of the overhanging ribs 30. The substantially rounded corner 505 of the shelf support 500 facilitates downward rotation of the shelf support 500 and acts to reduce and/or prevent any marring or dent formation in the vertical middle supports 20. In this manner, the shelf support 500 is secured in place as a result of the forces exerted between the vertical middle support 20, the shelf support 500 and knurled rod 510. Any number of shelf supports 500 may be installed on the bracket support system 10 to produce an adjustable and reconfigurable shelving system. Referring now specifically to FIGS. 33-34, the shelf support 500 may have a two-piece construction of a hollow cast support 535 and a support beam 540 that may be received and retained within the hollow cast support 535.

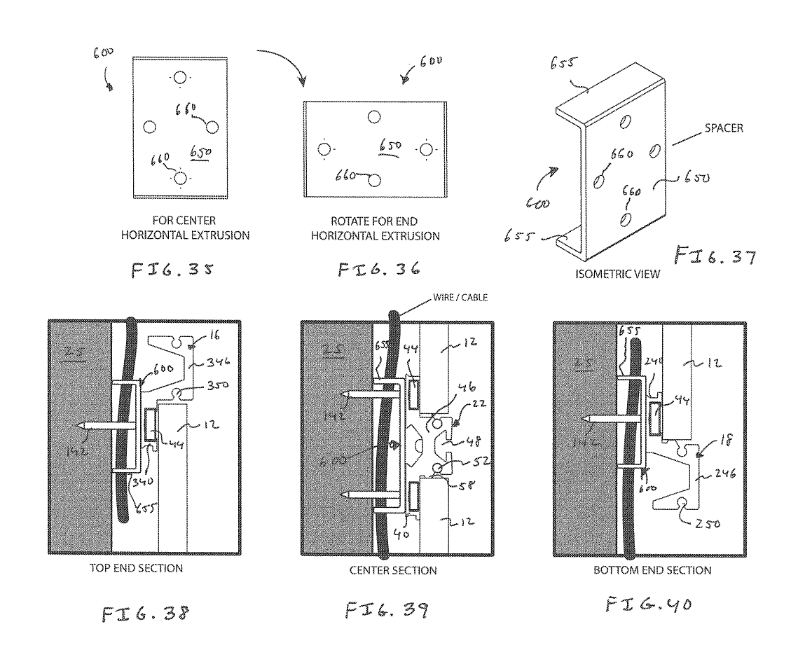

Referring now to FIGS. 35-40, an exemplary spacer 600 that may be used in accordance with the support bracket system 10 according to the present invention is shown. The spacer 600 may be used to elevate the support bracket system 10 away from the wall 25 or other surface on which it may be mounted. The spacer 600 may include a body portion 650 and a pair of legs 655 that act to space the spacer 600 away from the wall 25 or other surface so that mechanical, electrical and/or plumbing components may be placed between the wall 25 and the support bracket system 10. It is understood that the pair of legs 655 of the spacer 600 may have any appropriate height in order to accommodate the desired components, for example electrical cables as shown in FIGS. 38-40, that are placed between the wall 25 and the support bracket system 10. It is further understood that such spacers 600 allow junction boxes and other such components to be surface mounted to the wall 25, and then still be flush with the panels 12 installed on the support bracket system 10. As an additional alternative, junction boxes and other such components, such as outlets and switches, may extend from if the panels 12 if desired, or be recessed in the wall 25 so that no spacer 600 is required to make the junction boxes flush with the panels 12. The spacer 600 may also include one or more openings 660 to allow a suitable fastener 142 to be inserted from a support 16, 18, 22 through one of the openings 660 and into the wall in order retain the support bracket system 10, even when one or more spacers 600 are optionally used with the support bracket system 10.

The components of the bracket support system 10 may be constructed of any suitable material for the intended purpose of the bracket support system 10, and may preferably be constructed of extruded aluminum.

It will thus be seen that the objects set forth above, among those made apparent from the preceding description, are efficiently attained and, since certain changes may be made in the above article without departing from the scope of this invention, it is intended that all matter contained in this disclosure or shown in the accompanying drawings, shall be interpreted, as illustrative and not in a limiting sense. It is to be understood that all of the present figures, and the accompanying narrative discussions of corresponding embodiments, do not purport to be completely rigorous treatments of the invention under consideration. It is to be understood that the above-described arrangements are only illustrative of the application of the principles of the present invention. Numerous modifications and alternative arrangements may be devised by those skilled in the art without departing from the scope of the present invention.

What is claimed is:

1. A support bracket system, comprising:
at least one vertical support having a longitudinal body and at least one channel formed in the longitudinal body and extending along at least a portion of the longitudinal body; and
at least one horizontal support having a body portion and at least one central track formed in the body portion and extending along at least a portion of the body portion;
wherein the at least one horizontal support is configured for attachment to at least one of the at least one vertical supports; and
wherein when the at least one horizontal support is attached to the at least one vertical support one channel of the at least one channel of the vertical support is integral with one central track of the at least one track of the horizontal support.

2. The support bracket system according to claim 1, further comprising at least one support pin configured to connect the at least one vertical support with the at least one horizontal support, wherein the support pin comprises a head portion and a tapered body portion.

3. The support bracket system according to claim 2, wherein the at least one vertical support comprises at least one pin hole configured to receive the head portion of the support pin, wherein the at least one horizontal support comprises a longitudinal bore configured to receive the tapered body portion of the support pin.

4. The support bracket system according to claim 1, wherein the at least one channel of the vertical support comprises a first channel formed in a first side of the longitudinal body, and a second channel formed in a second side of the longitudinal body.

5. The support bracket system according to claim 4, wherein the first channel comprises an overhanging rib positioned on opposing sides of an opening to the first channel, and wherein each of the overhanging ribs comprises one or more teeth.

6. The support bracket system according to claim 1, wherein the horizontal support comprises at least one mounting track extending from the body portion and positioned substantially parallel with the central track.

7. The support bracket system according to claim 6, wherein the at least one mounting track is configured to slidenly receive one or more magnets.

8. The support bracket system according to claim 6, wherein the at least one mounting track comprises a groove configured to receive one or more fasteners.

9. The support bracket system according to claim 6, wherein the horizontal support comprises a ledge positioned on the body portion adjacent to one of the at least one mounting tracks.

10. The support bracket system according to claim 1, wherein the support bracket system is configured to support and retain at least one panel of a panel array.

11. The support bracket system according to claim 1, further comprising a shelf support received within the channel of the vertical support, and wherein the shelf support comprises a substantially rectangular support structure having at least one rounded corner, and a knurled rod configured for positioning within the channel of the vertical support.

12. The support bracket system according to claim 11, wherein the shelf support further comprises a hollow support having the at least one rounded corner, and a support beam configured for receipt within the hollow support.

13. The support bracket system according to claim 11, wherein the shelf support further comprises one or more posts extending from the rectangular support structure.

14. The support bracket system according to claim 1, wherein the at least one vertical support comprises a first vertical support and a second vertical support positioned substantially parallel to the first vertical support, and the at least one horizontal support comprises a first horizontal support and a second horizontal support positioned substantially parallel to the first horizontal support, and wherein the first vertical support is connected to the second vertical support by the first horizontal support and the second horizontal support.

15. The support bracket system according to claim 14, wherein at least one of the first horizontal support or the second horizontal support is attached to a surface by at least one fastener.

16. The support bracket system according to claim 14, wherein at least one panel is attached to the support bracket system and positioned so as to be bounded by the first vertical support, the second vertical support, the first horizontal support and the second horizontal support.

17. The support bracket system according to claim 1, wherein the central track of the at least one horizontal support comprises an opening and a substantially trapezoidal passage connected to the opening, wherein the cross-sectional size of the opening is less than the cross-sectional size of the passage.
